(19) United States
(12) Patent Application Publication
(10) Pub. No.: US 2021/0349317 A1
(43) Pub. Date: Nov. 11, 2021

(54) IMAGE DISPLAY DEVICE, HEAD-MOUNTED DISPLAY, METHOD FOR MANUFACTURING IMAGE DISPLAY DEVICE, AND METHOD FOR ADJUSTING IMAGE DISPLAY DEVICE

(71) Applicant: SONY CORPORATION, Tokyo (JP)

(72) Inventor: Takeshi YONEZAWA, Tokyo (JP)

(73) Assignee: SONY GROUP CORPORATION, Tokyo (JP)

(21) Appl. No.: 17/282,979

(22) PCT Filed: Oct. 2, 2019
(86) PCT No.: PCT/JP2019/039023

§ 371 Date: Apr. 5, 2021

(30) Foreign Application Priority Data
Oct. 15, 2018 (JP) 2018-194072

(51) Int. Cl. G02B 27/01; G02B 26/08

(52) U.S. Cl. CPC G02B 27/0172; G02B 27/0179; G02B 2027/0132; G02B 2027/0174; G02B 2027/0187; G02B 26/0833

(57) ABSTRACT

An image display device in which any difference in angle of view is eliminated. The image display device includes: an optical engine that emits image display light; and a light guide optical system that guides the image display light to an eye. In the image display device, the light guide optical system includes: a light adjustment unit that adjusts the image display light; and at least one light guide plate that causes the adjusted image display light to travel in the at least one light guide plate, and guides the image display light to the eye. The at least one light guide plate includes: an entrance portion that causes the adjusted image display light to travel into the light guide plate; and an exit portion that causes the image display light having traveled in the light guide plate to exit the light guide plate and reach the eye.

### TECHNICAL FIELD

The present technology relates to an image display device, a head-mounted display, a method for manufacturing an image display device, and a method for adjusting an image display device. More specifically, the present technology relates to an image display device including an optical engine and a light guide optical system, a head-mounted display including the image display device, a method for manufacturing the image display device, and a method for adjusting the image display device.

### BACKGROUND ART

In recent years, attention has been drawn to the technology for superimposing an image on a scene of the outside world. The technology is also called the augmented reality (AR) technology. One of the products using this technology is a head-mounted display. A head-mounted display is mounted on the user's head during use. By an image display method using a head-mounted display, when light from the head-mounted display, as well as light from the outside world, reaches the user's eyes, for example, the user feels as if the image formed by the light from the display were superimposed on an image of the outside world.

There is a head-mounted display that guides image display light emitted from an image display element to the user's eye with a light guide plate.

As such a display, Patent Document 1 described below discloses a flux diameter expanding optical element that expands the flux diameter of incoming light and then emits the light, for example. The flux diameter expanding optical element includes: a light guide member that has two surfaces facing each other, the two surfaces being parallel to each other; and a plurality of volume-phase holographic diffractive optical elements that is held at different sites in the plane of the light guide member. The holographic diffractive optical elements include: a first holographic diffractive optical element that performs diffraction so that incoming light from the outside into the light guide member is totally reflected in the light guide member; and a second holographic diffractive optical element that performs diffraction so that part of incoming light guided in the light guide member is emitted almost parallel to the incoming light into the light guide member in accordance with the diffraction efficiency, and totally reflects the remaining light. Where n is a natural number of 2 or greater, the first holographic diffractive optical element and the second holographic diffractive optical element each have interference fringes with n kinds of pitches that diffract light with n kinds of wavelengths at almost the same angle.

Meanwhile, Patent Document 2 described below discloses an optical device that includes: a first light guide member including a first light entrance portion and a first light exit portion; a second light guide member including a second light entrance portion and a second light exit portion; a first diffractive optical element that is provided at the second light exit portion of the second light guide member, and diffracts at least part of light having been guided in the second light guide member, to extract at least the part of the light out of the second light guide member; and a second diffractive optical element that is provided at the first light exit portion of the first light guide member, and extracts at least part of the light having been guided in the first light guide member and at least part of the light extracted by the first diffractive optical element. In the optical device, one of the incoming lights entering the first light guide member and the second light guide member enters the inside of the first light guide member from the first light entrance portion and is guided in the first light guide member, and another one of the incoming lights enters the inside of the second light guide member from the second light entrance portion and is guided in the second light guide member. The light being guided in the second light guide member includes a larger amount of light that is longer in wavelength than the light being guided in the first light guide member. The second diffractive optical element includes portions that differ in diffraction efficiency between the side closer to the first light entrance portion and the side farther from the first light entrance portion, and the diffraction efficiency of the first diffractive optical element is almost constant.

### CITATION LIST

### Patent Documents

Patent Document 1: Japanese Patent Application Laid-Open No. 2007-219106
Patent Document 2: Japanese Patent Application Laid-Open No. 2015-049376

### SUMMARY OF THE INVENTION

### Problems to be Solved by the Invention

In many displays that guide image display light emitted from an image display element to the user's eye with light guide plates, the image display light can be divided into a plurality of lights having wavelength components different from one another, and be guided to the eye. The angles of view of the images formed by the plurality of lights are required not to differ from one another.

The present technology mainly aims to provide an image display device in which any difference in angle of view is eliminated.

### Solutions to Problems

The present technology provides

an image display device that includes: an optical engine that emits image display light; and a light guide optical system that guides the image display light emitted from the optical engine to an eye,

in which

the light guide optical system includes: a light adjustment unit that adjusts the image display light emitted from the optical engine; and at least one light guide plate that causes the image display light adjusted by the light adjustment unit to travel in the at least one light guide plate, and guides the image display light to the eye, and

the at least one light guide plate includes: an entrance portion that causes the image display light adjusted by the light adjustment unit to travel into the light guide plate; and an exit portion that causes the image display light having traveled in the light guide plate to exit the light guide plate and reach the eye.

The light adjustment unit may reflect or refract the image display light emitted from the optical engine, and cause the image display light to travel to the entrance portion.

The entrance portion may diffract the image display light adjusted by the light adjustment unit, and cause the image display light to travel into the light guide plate.

The light adjustment unit may divide the image display light emitted from the optical engine into two or more lights having different wavelength components, and cause the lights to travel to the entrance portion.

According to one embodiment of the present technology, the light guide optical system may include two or more light guide plates, an entrance hologram may be provided at the entrance portion of each of the two or more light guide plates, and the entrance hologram may diffract one of the two or more lights divided by the light adjustment unit and cause the one light to travel into the light guide plate.

An exit hologram may be provided at an exit portion of each of the two or more light guide plates, and the exit hologram may diffract the light having traveled in the light guide plate, and cause the light to exit the light guide plate.

According to another embodiment of the present technology, the light guide optical system may include one light guide plate, an entrance hologram may be provided at the entrance portion of the one light guide plate, and the entrance hologram may diffract the two or more lights divided by the light adjustment unit and cause the two or more lights to travel into the light guide plate.

The entrance hologram may be a hologram stack.

An exit hologram may be provided at an exit portion of the one light guide plate, and the diffraction pitch of the exit hologram may differ from the diffraction pitch of the entrance hologram.

According to one embodiment of the present technology, the light adjustment unit may include at least one dichroic mirror, and the image display light emitted from the optical engine may be divided into the two or more lights by the at least one dichroic mirror.

According to another embodiment of the present technology, the light guide optical system may include two or more light guide plates, the light adjustment unit may include one liquid crystal element or MEMS mirror, and the one liquid crystal element or MEMS mirror may switch the light guide plates to which the image display light emitted from the optical engine is to be guided.

The optical engine may be driven by a field sequential method, and the one liquid crystal element or MEMS mirror may change its steering in synchronization with the driving by the field sequential method.

According to yet another embodiment of the present technology, the light guide optical system may include two or more light guide plates, the light adjustment unit may include one liquid crystal element, and the hologram generated by the liquid crystal element may switch the light guide plates to which the image display light emitted from the optical engine is to be guided.

According to still another embodiment of the present technology, the light adjustment unit may include at least one mirror having a lens function.

According to one embodiment of the present technology, the position and/or the orientation of the entire light adjustment unit can be adjusted, to cause the image display light emitted from the optical engine to reach a desired position in the at least one light guide plate.

According to one embodiment of the present technology, an image signal directed to an image display element included in the optical engine can be adjusted, to cause the image display light emitted from the optical engine to reach a desired position in the at least one light guide plate.

The present technology also provides a head-mounted display that includes

at least one image display device including: an optical engine that emits image display light; and a light guide optical system that guides the image display light emitted from the optical engine and causes the image display light to reach an eye,

in which

the light guide optical system includes: a light adjustment unit that adjusts the image display light emitted from the optical engine; and at least one light guide plate that causes the image display light adjusted by the light adjustment unit to travel in the at least one light guide plate, and guides the image display light to the eye, and

the at least one light guide plate includes: an entrance portion that causes the image display light adjusted by the light adjustment unit to travel into the light guide plate; and an exit portion that causes the image display light having traveled in the light guide plate to exit the light guide plate and reach the eye.

The present technology also provides a method for manufacturing an image display device, the method including:

an assembly process of assembling an image display device from an optical engine that emits image display light, a light adjustment unit that adjusts the image display light emitted from the optical engine, and at least one light guide plate, to cause the image display light adjusted by the light adjustment unit to travel in the at least one light guide plate and guide the image display light to an eye; and

an adjustment process of adjusting the light adjustment unit, to cause the image display light emitted from the optical engine to reach a desired position in the at least one light guide plate, after the assembly process.

In the assembly process, two image display devices may be assembled from two sets of the optical engine, the light adjustment unit, and the at least one light guide plate. In the adjustment process, the light adjustment unit included in one or both of the two image display devices may be adjusted to adjust the angle of convergence, or an image signal directed to an image display element of the optical engine included in one or both of the two image display devices may be adjusted to adjust the angle of convergence.

The present technology also provides a method for adjusting an image display device, the method including: a preparation process of preparing an image display device including an optical engine that emits image display light, a light adjustment unit that adjusts the image display light emitted from the optical engine, and at least one light guide plate that causes the image display light adjusted by the light adjustment unit to travel in the at least one light guide plate and guides the image display light to an eye; and an adjustment process of adjusting the light adjustment unit, to cause the image display light emitted from the optical engine to reach a desired position in the at least one light guide plate.

### BRIEF DESCRIPTION OF DRAWINGS

FIG. 1 is a schematic diagram of an example of an image display device according to the present technology.

FIG. 2 is a schematic diagram of an example of an image display device according to the present technology.

FIG. 3 is a schematic diagram of an example of a head-mounted display according to the present technology.

FIG. 4 is a schematic diagram of an example of an image display device according to the present technology.

FIG. 5 is a schematic diagram of an example of an image display device according to the present technology.

FIG. 6 is a schematic diagram of an example of an image display device according to the present technology.

FIG. 7 is an example flow of a manufacturing method according to the present technology.

FIG. 8 is a schematic diagram of an example of an image display device according to the present technology.

FIG. 9 is a schematic diagram of an example of an image display device according to the present technology.

FIG. 10 is an example flow of an adjustment method according to the present technology.

### MODE FOR CARRYING OUT THE INVENTION

The following is a description of preferred embodiments for carrying out the present technology. Note that the embodiments described below are typical embodiments of the present technology, and the scope of the present technology is not limited to these embodiments. Note that explanation of the present technology will be made in the following order.

1. First embodiment (an image display device)

(1) Description of the first embodiment

(2) First example of the first embodiment (an example of an image display device)

(3) Second example of the first embodiment (another example of an image display device)

(4) Third example of the first embodiment (another example of an image display device)

(5) Fourth example of the first embodiment (another example of an image display device)

2. Second embodiment (a head-mounted display)

3. Third embodiment (a method for manufacturing an image display device)

4. Fourth embodiment (a method for adjusting an image display device)

### 1. First Embodiment (An Image Display Device)

### (1) Description of the First Embodiment

An image display device according to the present technology includes an optical engine that emits image display light, and a light guide optical system that guides the image display light emitted from the optical engine and causes the image display light to reach an eye. The light guide optical system includes a light adjustment unit that adjusts the image display light emitted from the optical engine, and one or more light guide plates that cause the image display light adjusted by the light adjustment unit to travel therein and reach the eye. That is, the image display device according to the present technology has the light adjustment unit disposed in the optical path between the optical engine and the light guide plate. The light adjustment unit can be used to eliminate a difference in angle of view.

As a difference in angle of view can be eliminated by the light adjustment unit, there is no need to precisely adjust the position of the light guide plate to eliminate a difference in angle of view during the manufacture of the image display device. More specifically, after the image display device is assembled from the optical engine and the light guide optical system, the difference in angle of view can be eliminated by adjusting the light adjustment unit. Accordingly, the equipment for manufacturing the image display device can be simplified. Further, in a case where a difference is generated in angle of view after the manufacture of the image display device, it is possible to easily repair or adjust the image display device by adjusting the light adjustment unit.

It is also conceivable to use image display devices of the present technology, to form a head-mounted display with which the devices are placed in front of both eyes. Since the image display devices included in the display include the light adjustment units, the convergence of the display can also be adjusted by the light adjustment units. Further, the optical axes of both eyes of the display can be easily aligned.

The flux diameter expanding optical element disclosed in Patent Document 1 described above includes a first holographic diffractive optical element and a second holographic diffractive optical element, and each of the two holographic diffractive optical elements has interference fringes with n kinds of pitches that diffract lights of n kinds of wavelengths at almost the same angle. For example, in a case where the lights of the n kinds of wavelengths are lights of the red, green, and blue wavelengths, the interference fringes need to be created with high precision, to prevent differences in angle of view among the lights of the respective wavelengths (such differences will be hereinafter also referred to as registration differences). Also, to prevent the registration differences, it is necessary to strictly manage and maintain the equipment for manufacturing the flux diameter expanding optical element, which complicates the manufacturing equipment.

As described above, an image display device according to the present technology has the light adjustment unit disposed in the optical path between the optical engine and the light guide plate. As registration differences can be eliminated by the light adjustment unit, the accuracy of creation of the entrance portion and the exit portion of the light guide plate may be lowered. Accordingly, the costs for managing and maintaining the equipment for producing the image display device can be lowered, and the production equipment can be made simpler.

The optical device disclosed in Patent Document 2 described above includes a first light guide member and a second light guide member, and it is preferable to prevent generation of a difference in angle of view between two lights emitted from these two light guide members. To prevent a registration difference, it is necessary to accurately form the diffraction pitch of the diffractive optical element provided in each light guide member. Further, since the optical device includes the two light guide members, it is also necessary to accurately secure these two light guide members so as not to generate any registration difference. To secure these two light guide members with high precision, it might be possible to use specific securing members and secure the positions of these two light guide members while viewing a video image formed by the two lights, for example. However, such an operation is time consuming or costly.

As described above, an image display device of the present technology can eliminate a registration difference with the light adjustment unit. In a case where the image display device of the present technology includes two light guide plates, for example, the positional relationship between the two light guide plates is secured, and adjustment is then performed by the light adjustment unit, so that any registration difference can be eliminated. In this case, the positional relationship between the two light guide plates does not need to be secured with high precision, and the tolerance of manufacture of the light guide plates can be increased.

In the present technology, the light adjustment unit can be used to eliminate the registration difference. The light adjustment unit can reflect or refract the image display light emitted from the optical engine, and cause the image display light to reach the entrance portion, for example. To reflect the image display light, the light adjustment unit may include a plurality of mirrors, for example. At least one mirror of the plurality of mirrors may be a dichroic mirror. The dichroic mirror can divide the image display light into two lights having different wavelength components from each other. To refract the image display light, the light adjustment unit may include at least one mirror having a lens function, for example.

The light adjustment unit can divide the image display light emitted from the optical engine into two or more lights having different wavelength components, and cause the two or more lights to travel to the entrance portion. The light adjustment unit preferably includes at least one dichroic mirror, and the image display light emitted from the optical engine can be divided into the two or more lights by the at least one dichroic mirror. The two or more lights may be guided to the inside of each of the plurality of light guide plates, or may be guided to the inside of one light guide plate. The number of light guide plates included in the image display device of the present technology may be one to ten, or more particularly, two to six, for example.

The image display light adjusted by the light adjustment unit reaches the light guide plate. The entrance portion of the light guide plate may diffract or reflect the image display light adjusted by the light adjustment unit and cause the image display light to travel into the light guide plate, for example. More preferably, the entrance portion may diffract the image display light and cause the image display light to travel into the light guide plate. To diffract the image display light, the entrance portion may include a hologram, or more particularly, a reflective or transmissive hologram, for example. Alternatively, to reflect the image display light, the entrance portion may include a multi-mirror array, for example. For ease of manufacture, the entrance portion may include a reflective or transmissive hologram. The same applies to the exit portion.

### (2) First Example of the First Embodiment (An Example of an Image Display Device)

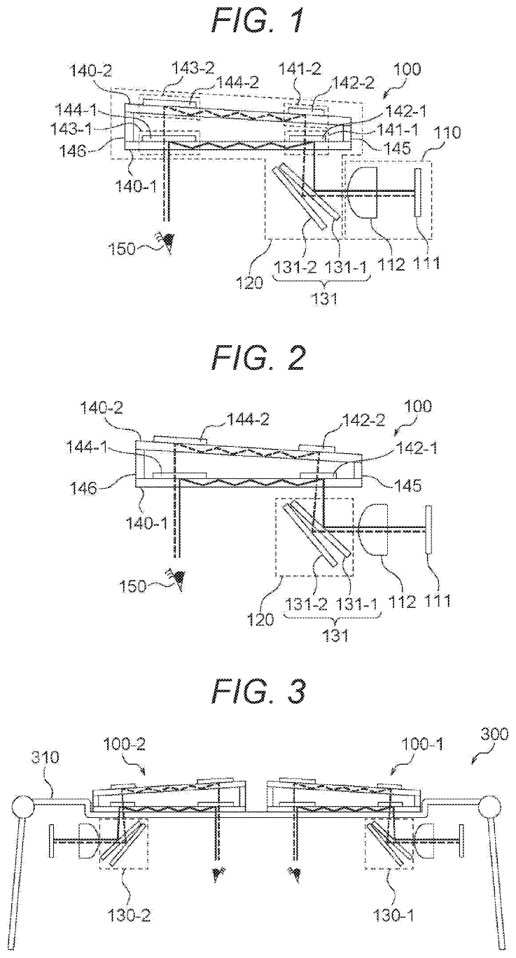

According to one embodiment of the present technology, the light guide optical system may include two or more light guide plates, an entrance hologram may be provided at the entrance portion of each of the two or more light guide plates, and the entrance hologram may diffract one of the two or more lights divided by the light adjustment unit and cause the one light to travel into the light guide plate. An example of an image display device according to this embodiment is described below with reference to FIG. 1.

FIG. 1 shows an example schematic diagram of an image display device 100 according to the present technology. The image display device 100 includes an optical engine 110 and a light guide optical system 120. The optical engine 110 optically processes light emitted from a light source device (not shown) to form image display light, and then emits the light toward the light guide optical system. The light guide optical system 120 guides the image display light emitted from the optical engine 110 to an eye 150. The optical engine 110 includes an image display element 111 and a collimator lens 112, for example. The light guide optical system 120 includes a light adjustment unit 131 and two light guide plates 140-1 and 140-2. These components will be described below in greater detail.

The image display element 111 optically processes light emitted from the light source device to form image display light, and emits the image display light toward the collimator lens 112. The image display element 111 may be a liquid crystal display element, or more particularly, a reflective liquid crystal element, a transmissive liquid crystal element, or a semi-transmissive liquid crystal element, for example. The collimator lens 112 converts the image display light emitted from the image display element 111 into parallel lights. Optical elements known in the art may be used as the image display element 111 and the collimator lens 112.

The emission of the image display light by the image display element 111 can be controlled by a control unit (not shown), for example. That is, the image display device 100 may include a control unit (not shown) that controls the image display element 111 emitting the image display light. The control unit may include a central processing unit (CPU) and a RAM, for example. Any appropriate processor may be used as the CPU. The RAM includes a cache memory and a main memory, for example, and can temporarily store programs to be used by the CPU. The image display device 100 may further include various components, such as a disk, a communication device, and a drive, to be used for controlling the image display element, for example. The disk can store various programs such as a program for realizing the emission of the image display light by the image display element 111, and various kinds of image data, for example. The communication device can acquire, from a network, for example, a program and/or image data for controlling the image display element. The drive can read a program and/or image data recorded on a recording medium such as a micro SD memory card or an SD memory card, for example, and output the program and/or the image data to the RAM.

The light adjustment unit 131 adjusts the image display light emitted from the optical engine 110. The light adjustment unit 131 includes two mirrors 131-1 and 131-2, for example, as shown in FIG. 1.

The mirror 131-1 can reflect the image display light that should be guided by the light guide plate 140-1 among the image display lights emitted from the optical engine 110, and pass the other image display lights. The mirror 131-1 may be a dichroic mirror, for example.

The mirror 131-2 can reflect the image display light that should be guided by the light guide plate 140-2 among the image display lights having passed through the mirror 131-1, and pass the other image display lights. That is, the mirror 131-2 may be a dichroic mirror. Alternatively, the mirror 131-2 may reflect all the image display light that has passed through the mirror 131-1.

The types and/or the optical characteristics of the mirrors 131-1 and 131-2 may be appropriately selected by a person skilled in the art in accordance with the image display lights to be guided by the light guide plates 140-1 and 140-2.

In this example, the mirror 131-1 reflects the green image display light and passes the image display light of the other colors, and the mirror 131-2 reflects the magenta image display light and passes the image display light of the other colors.

Note that the wavelength range of the image display light to be reflected by each mirror may be selected by a person skilled in the art, as appropriate. Also, a person skilled in the art can manufacture the mirrors that reflect only light in desired wavelength ranges.

Although the number of mirrors included in the light adjustment unit 131 is two, the number of mirrors included in the light adjustment unit in an image display device of the present technology may be appropriately selected by a person skilled in the art, in accordance with the number of entrance portions, the number of light guide plates, and/or the like to be reached by the image display light, for example. The number of mirrors is two or larger, for example, or preferably two to ten, or more preferably two to six. Also, the arrangement of the mirrors may be appropriately selected by a person skilled in the art so that the image display light reaches a desired entrance portion. For example, in a case where there are three light guide plates, three mirrors are provided, and each of the three mirrors is placed so that the image display light having a predetermined wavelength component reaches the entrance portion of each corresponding one of the three light guide plates. Therefore, the three mirrors are arranged so as to align in the traveling direction of the image display light emitted from the optical engine in a manner similar that in FIG. 1. The two of the three mirrors that are closer to the optical engine may be dichroic mirrors, and the remaining one may be a dichroic mirror or a total reflection mirror.

The light adjustment unit 131 is disposed in the optical path between the collimator lens 112 that converts the image display light emitted from the image display element 111 into parallel light, and the light guide plates 140-1 and 140-2. Such arrangement is suitable for the light adjustment unit to eliminate a difference in the angle of view. As shown in FIG. 1, only the light adjustment unit 131 may be disposed in the optical path, or an optical element such as a mirror may be provided depending on the configuration of the image display device, for example.

The green image display light (indicated by a solid line) reflected by the mirror 131-1 reaches the entrance portion 141-1 of the light guide plate 140-1. The entrance portion 141-1 causes the green image display light to travel into the light guide plate 140-1. An entrance hologram 142-1 is provided at the entrance portion 141-1, and the entrance hologram 142-1 diffracts the green image display light and causes the green image display light to travel into the light guide plate 140-1. The entrance hologram 142-1 may be a holographic optical element (HOE), for example. The entrance hologram 142-1 may also have optical characteristics to selectively diffract the light reflected by the mirror 131-1.

As shown in FIG. 1, the entrance hologram 142-1 may be stacked on the surface of the light guide plate 140-1 that is farther from the mirror 131-1 between the two surfaces of the light guide plate 140-1, or may be stacked on the surface closer to the mirror 131-1 between the two surfaces.

The entrance portion 141-1 is only required to be designed to cause the image display light to travel into the light guide plate 140-1, and may include an optical element that is not a hologram. For example, the entrance portion 141-1 may have a multi-mirror array in place of the entrance hologram 142-1.

The magenta image display light (indicated by a dashed line) reflected by the mirror 131-2 passes through the light guide plate 140-1 and the entrance hologram 142-1, and reaches the entrance portion 141-2 of the light guide plate 140-2. The entrance portion 141-2 causes the magenta image display light to travel into the light guide plate 140-2. An entrance hologram 142-2 is provided at the entrance portion 141-2, and the entrance hologram 142-2 diffracts the magenta image display light and causes the magenta image display light to travel into the light guide plate 140-2. The entrance hologram 142-2 may also be a holographic optical element (HOE), for example. The entrance hologram 142-2 may also have optical characteristics to selectively diffract the light reflected by the mirror 131-2.

As shown in FIG. 1, the entrance hologram 142-2 may also be stacked on the surface of the light guide plate 140-2 that is farther from the mirror 131-2 between the two surfaces of the light guide plate 140-2, or may be stacked on the surface closer to the mirror 131-2 between the two surfaces.

The entrance portion 141-2 may have a multi-mirror array in place of the entrance hologram 142-2, as described above with respect to the entrance portion 141-1.

The light adjustment unit 131 may be designed to be capable of adjusting that the position(s) and/or the angle(s) of the mirror 131-1 and/or the mirror 131-2.

For example, the mirror 131-1 may be designed so that its position and/or angle can be adjusted, while the position and/or the angle of the mirror 131-2 is secured. As the position and/or the angle of the mirror 131-1 is adjusted, the angle of view of the image formed by the green image display light can be matched with the angle of view of the image formed by the magenta image display light.

Alternatively, the mirror 131-2 may be designed so that its position and/or angle can be adjusted, while the position and/or the angle of the mirror 131-1 is secured. As the position and/or the angle of the mirror 131-2 is adjusted, the angle of view of the image formed by the magenta image display light can be matched with the angle of view of the image formed by the green image display light.

Alternatively, the mirror 131-1 and the mirror 131-2 may be designed so that the positions and/or the angles of both the mirror 131-1 and the mirror 131-2 can be adjusted.

As described above, in the present technology, the mirrors constituting the light adjustment unit may be designed so that the position and/or the angle of at least one of the mirrors can be adjusted. The position(s) and/or the angle(s) of the mirror(s) may be adjusted by a technique known in the art, for example. The securing part (a screw or the like, for example) that secures the holder of a mirror is loosened, and the position and/or the angle of the mirror is then adjusted, for example.

The light adjustment unit 131 may also be designed to be capable of adjusting the position and/or the angle of the entire image display light emitted from the optical engine so that the image display light reaches a desired position in at least one of the light guide plates. With this arrangement, the projection position and/or the angle of the entire image can be adjusted.

The light guide plate 140-1 totally reflects the image display light that has been diffracted by the entrance hologram 142-1 and traveled into the light guide plate 140-1, and thus, guides the image display light to an exit portion 143-1.

Like the light guide plate 140-1, the light guide plate 140-2 totally reflects the image display light that has been diffracted by the entrance hologram 142-2 and traveled into the light guide plate 140-2, and thus, guides the image display light to an exit portion 143-2.

The light guide plates 140-1 and 140-2 may include a light guide plate material known in the art. For example, the light guide plates 140-1 and 140-2 may include an acrylic resin (PMMA or the like, for example), a cycloolefin resin (COP or the like, for example), or a polycarbonate resin.

Each of the light guide plates 140-1 and 140-2 may have a size capable of covering at least part of the field of view of one eye, for example. More specifically, each of the light guide plates 140-1 and 140-2 may have a size similar to that of a spectacle lens. Each of the light guide plates 140-1 and 140-2 preferably has a size that can be supported by a spectacle-shaped frame. In a case where each of the light guide plates 140-1 and 140-2 is too large, the light guide plates 140-1 and 140-2 might be an excessive burden on the user who uses the image display device.

The relative positional relationship between the light guide plates 140-1 and 140-2 is secured by securing members 145 and 146. The securing members 145 and 146 may be an adhesive that is known in the art and is used for bonding light guide plates to each other. Alternatively, fasteners such as bolts or screws may be used as the securing members 145 and 146.

Both the light guide plates 140-1 and 140-2 may pass external light. With this arrangement, the external light, as well as the image display light, reaches the eye 150. That is, the image formed by the image display light is superimposed on the external landscape. Thus, the image display device 100 can provide AR to the user.

Although the number of light guide plates included in the light guide optical system 120 of this embodiment is two, the number of light guide plates is not necessarily two and may be two or larger in the present technology. The light guide optical system included in an image display device of the present technology may include two or more light guide plates, or preferably includes two to ten light guide plates, or more preferably includes two to six light guide plates, for example. In a case where the number of light guide plates is too large, the manufacturing process might become complicated.

The exit portion 143-1 causes the green image display light to exit the light guide plate 140-1 and reach the eye 150. An exit hologram 144-1 is provided on the exit portion 143-1, and the exit hologram 144-1 diffracts the green image display light and causes the green image display light to exit the light guide plate 140-1. The exit hologram 144-1 may be a holographic optical element (HOE), for example. The exit hologram 144-1 may also have optical characteristics to selectively diffract the green image display light.

As shown in FIG. 1, the exit hologram 144-1 may be stacked on the surface of the light guide plate 140-1 that is farther from the eye 150 between the two surfaces of the light guide plate 140-1, or may be stacked on the surface closer to the eye 150 between the two surfaces.

Like the exit portion 143-1, the exit portion 143-2 causes the magenta image display light to exit the light guide plate 140-2 and reach the eye 150. An exit hologram 144-2 is provided on the exit portion 143-2, and the exit hologram 144-2 diffracts the green image display light and causes the green image display light to exit the light guide plate 140-2. The exit hologram 144-2 may be a holographic optical element (HOE), for example. The exit hologram 144-2 may also have optical characteristics to selectively diffract the magenta image display light.

As shown in FIG. 1, the exit hologram 144-2 may also be stacked on the surface of the light guide plate 140-2 that is farther from the eye 150 between the two surfaces of the light guide plate 140-2, or may be stacked on the surface closer to the eye 150 between the two surfaces.

As described above, an exit hologram may be provided on each exit portion of the two or more light guide plates included in an image display device of the present technology. The exit holograms can diffract the light that has traveled through the light guide plates and cause the light to exit the light guide plates.

The exit portion 143-1 is only required to be designed to cause the image display light to exit the light guide plate 140-1, and may include an optical element that is not a hologram. For example, the exit portion 143-1 may have a multi-mirror array in place of the exit hologram 144-1.

The exit portion 143-2 may have a multi-mirror array in place of the exit hologram 144-2, as described above with respect to the exit portion 143-1.

(Adjustment by Moving the Mirrors)

For example, after the image display device 100 is assembled as shown in FIG. 1, the position and/or the angle of one or both of the mirrors constituting a light adjustment unit 130 can be adjusted. By this adjustment, it is possible to eliminate the registration difference between the image formed by the green image display light and the image formed by the magenta image display light.

In the present technology, the adjustment of the position can mean adjustment of the relative position of each mirror with respect to the optical engine and the light guide plate (particularly the entrance portion), for example. Further, in the present technology, the adjustment of the angle can mean adjustment of the angle of incidence or the angle of reflection of the image display light emitted from the optical engine onto the mirror.

For example, as the position and/or the angle of the mirror 131-1 is adjusted, the angle of view of the image formed by the green image display light can be matched with the angle of view of the image formed by the magenta image display light. Alternatively, as the position and/or the angle of the mirror 131-2 is adjusted, the angle of view of the image formed by the magenta image display light can be matched with the angle of view of the image formed by the green image display light. Also, the positions and/or the angles of both of the mirrors 131-1 and 131-2 may be adjusted to make the angles of view of the two images equal to each other.

As described above, an image display device of the present technology can eliminate a registration difference with its light adjustment unit. Therefore, the relative positional relationship between the two light guide plates 140-1 and 140-2 does not have to be strictly controlled. For example, as a registration difference can be eliminated by the light adjustment unit, the securing operation to be performed on the light guide plates 140-1 and 140-2 by the securing members 145 and 146 can be simplified.

(Adjustment by Moving the Entire Light Adjustment Unit)

After the image display device 100 is assembled as shown in FIG. 1, for example, the position and/or the angle of the entire light adjustment unit 130 can be adjusted as shown in FIG. 2. By this adjustment, the position of the image formed by the green image display light and the magenta image display light can be moved.

(Adjustment of Convergence)

For example, as shown in FIG. 3, a head-mounted display 300 that places two image display devices according to the present technology in front of both eyes may be formed. In the head-mounted display 300, two image display devices 100 described above are mounted on a support 310 in the form of a spectacle frame. In FIG. 3, the two image display devices are denoted by reference numerals 100-1 and 100-2, respectively. The image display device 100-1 is disposed so that image display light reaches one of the eyes, and the image display device 100-2 is disposed so that image display light reaches the other one of the eyes. The light guide plates included in the image display devices can be placed at the positions corresponding to the lens portions of spectacles.

The light adjustment unit 130-1 is designed so that its overall position and/or angle can be adjusted. Likewise, the light adjustment unit 130-2 is also designed so that its overall position and/or angle can be adjusted. As the position(s) and/or the angle(s) of the light adjustment unit 130-1 and/or the light adjustment unit 130-2 are adjusted, so that convergence can be adjusted. For example, the angle of convergence can be adjusted, without any missing portion in the image formed by the image display light.

In the present technology, to adjust the angle of convergence, an image signal to be transmitted to the image display element 111 included in the optical engine 110 may be adjusted. The adjustment of the image signal may be performed on one or both of the image display devices 100-1 and 100-2. As described above, an image display device of the present technology can adjust an image signal for the image display element included in the optical engine so that the image display light emitted from the optical engine reaches desired positions in the light guide plates.

### (3) Second Example of the First Embodiment (Another Example of an Image Display Device)

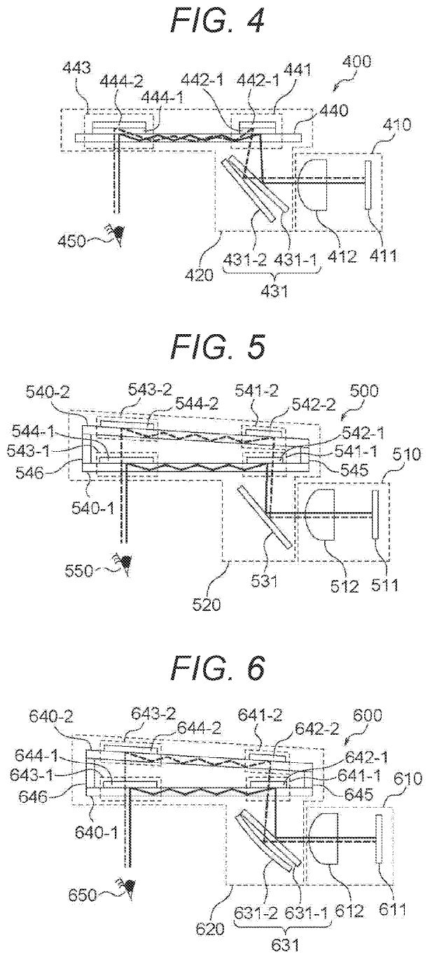

According to another embodiment of the present technology, the light guide optical system may include one light guide plate, an entrance hologram may be provided at the entrance portion of the one light guide plate, and the entrance hologram may diffract the two or more lights divided by the light adjustment unit and cause the two or more lights to travel into the light guide plate. An example of an image display device according to this embodiment is described below with reference to FIG. 4.

FIG. 4 shows an example schematic diagram of an image display device 400 according to the present technology. The image display device 400 includes an optical engine 410 and a light guide optical system 420. Because the optical engine 410 is the same as the optical engine 110 described above in “(2) First Example of the First Embodiment (an Example of an Image Display Device)”, explanation thereof is not repeated herein. The light guide optical system 420 guides the image display light emitted from the optical engine 410 to an eye 450. The light guide optical system 420 includes a light adjustment unit 431 and one light guide plate 440. The light guide optical system 420 will be described below in greater detail.

The light adjustment unit 431 adjusts the image display light emitted from the optical engine 410. The light adjustment unit 431 includes two mirrors 431-1 and 431-2, for example, as shown in FIG. 4. The mirror 431-1 reflects the green image display light and passes the image display light of the other colors, and the mirror 431-2 reflects the magenta image display light and passes the image display light of the other colors. The light adjustment unit 431, and the mirror 431-1 and the mirror 431-2 included therein are the same as the light adjustment unit 131, and the mirror 131-1 and the mirror 131-2 described above in “(2) First Example of the First Embodiment (an Example of an Image Display Device)”, respectively, and therefore, explanation of them is not repeated herein.

Both the green image display light reflected by the mirror 431-1 and the magenta image display light reflected by the mirror 431-2 reach the entrance portion 441 of the light guide plate 440. The entrance portion 441 causes these image display lights to travel into the light guide plate 440. For example, entrance holograms 442-1 and 442-2 are provided at the entrance portion 441, to cause the green image display light to travel into the light guide plate 440. Each of the entrance holograms 442-1 and 442-2 may be a holographic optical element (HOE), for example. The entrance hologram 442-1 may have optical characteristics to selectively diffract the light reflected by the mirror 431-1. The entrance hologram 442-2 may have optical characteristics to selectively diffract the light reflected by the mirror 431-2.

The entrance holograms 442-1 and 442-2 may be stacked as shown in FIG. 4. In this manner, the entrance holograms provided at the entrance portion can be a hologram stack.

Alternatively, the entrance holograms 442-1 and 442-2 may be disposed at different positions in the entrance portion 441 so as not to overlap each other.

The light guide plate 440 totally reflects the image display light that was made to travel into the light guide plate 440 by the entrance hologram 442-1, and thus, guides the image display light to an exit portion 443. The light guide plate 440 also totally reflects the image display light that was made to travel into the light guide plate 440 by the entrance hologram 442, and thus, guides the image display light to the exit portion 443.

The light guide plate 440 may include a light guide plate material known in the art. For example, the light guide plate 440 may include an acrylic resin (PMMA or the like, for example), a cycloolefin resin (COP or the like, for example), or a polycarbonate resin.

The exit portion 443 causes the green image display light to exit the light guide plate 440 and reach the eye 450. For example, an exit hologram 444-1 is provided at the exit portion 443, to cause the green image display light to exit the light guide plate 440. The exit hologram 444-1 may be a holographic optical element (HOE), for example. The exit hologram 444-1 may also have optical characteristics to selectively diffract the green image display light.

The exit portion 443 also causes the magenta image display light to exit the light guide plate 440 and reach the eye 450. For example, an exit hologram 444-2 is provided at the exit portion 443, to cause the magenta image display light to exit the light guide plate 440. The exit hologram 444 may also be a holographic optical element (HOE), for example. The exit hologram 444-2 may also have optical characteristics to selectively diffract the magenta image display light.

The exit holograms 444-1 and 444-2 may be stacked as shown in FIG. 4. In this manner, the exit holograms provided at the exit portion can be a hologram stack.

Alternatively, the exit holograms 444-1 and 444-2 may be disposed at different positions in the exit portion 443 so as not to overlap each other.

In the image display device 400 shown in FIG. 4, the entrance holograms 442-1 and 442-2, and the exit holograms 444-1 and 444-2 are disposed (stacked) on the one light guide plate 440. Each of these holograms has a predetermined diffraction pitch. In the present technology, the diffraction pitch of the exit holograms is preferably the same as the diffraction pitch of the entrance holograms. For example, in a case where the diffraction pitch of magenta differs from the designed value, a difference is generated between the angle of view of the green image display light and the angle of view of the magenta display angle light. The difference between the angle of view of the green image display light and the angle of view of the magenta image display light can be eliminated by adjustment of the positions and/or the angles of the mirrors 431-1 and 431-2 included in the light adjustment unit 431.

### (4) Third Example of the First Embodiment (Another Example of an Image Display Device)

According to another embodiment of the present technology, the light adjustment unit may include one liquid crystal element or scan mirror, and the one liquid crystal element or MEMS (Micro Electro Mechanical Systems) mirror may switch the light guide plates to which the image display light emitted from the optical engine is to be guided.

In this embodiment, the optical engine is driven by a field sequential method, for example, and the one liquid crystal element or MEMS mirror may change its steering in synchronization with the driving by the field sequential method.

Alternatively, in this embodiment, the light guide optical system may include two or more light guide plates, the light adjustment unit may include one liquid crystal element, and the hologram generated by the liquid crystal element may switch the light guide plates to which the image display light emitted from the optical engine is to be guided.

An example of an image display device according to this embodiment is described below with reference to FIG. 5.

FIG. 5 shows an example schematic diagram of an image display device 500 according to the present technology. The image display device 500 includes an optical engine 510 and a light guide optical system 520. The optical engine 510 emits image display light. The light guide optical system 520 guides the image display light emitted from the optical engine 510 to an eye 550. The optical engine 510 includes an image display element 511 and a collimator lens 512. The light guide optical system 520 includes a light adjustment unit 531 and two light guide plates 540-1 and 540-2. These components will be described below in greater detail.

The image display element 511 may be a liquid crystal display element that is driven by a field sequential method, for example. That is, the image display element 511 can sequentially emit a plurality of image display lights (red, green, and blue, for example) having different wavelengths. The collimator lens 512 converts the image display lights emitted from the image display element 511 into parallel lights. Optical elements known in the art may be used as the image display element 511 and the collimator lens 512.

The light adjustment unit 531 adjusts the image display lights emitted from the optical engine 510. For example, the light adjustment unit 531 may include one liquid crystal element or one MEMS mirror. The liquid crystal element or the MEMS mirror may change its steering in synchronization with the driving by the field sequential method. For example, when green image display light is emitted from the image display element 511, the liquid crystal element or the MEMS mirror changes its steering so that the green image display light is diffracted by an entrance hologram 542-1 and is guided into the light guide plate 540-1. Also, when magenta image display light is emitted from the image display element 511, the liquid crystal element or the MEMS mirror changes its steering so that the magenta image display light is diffracted by an entrance hologram 542-2 and is guided into the light guide plate 540-2. In this manner, the steering of the liquid crystal element or the MEMS mirror can be synchronized with the driving of the image display element 511 by the field sequential method.

Alternatively, the light adjustment unit 531 may include one liquid crystal element, and the liquid crystal element may generate a hologram that diffracts two or more lights having different wavelength components at different angles from each other. The hologram can diffract the green image display light of the image display lights emitted from the image display element 511 so that the green image display light is diffracted by the entrance hologram 542-1 and is guided into the light guide plate 540-1, for example. The hologram can also diffract the magenta image display light of the image display lights emitted from the image display element 511 so that the magenta image display light is diffracted by the entrance hologram 542-2 and is guided into the light guide plate 540-2. In a case where image display lights are adjusted by the hologram formed in the light adjustment unit 531 in this manner, the image display element 511 is not necessarily driven by the field sequential method, and the control on the image display element 511 becomes easier.

As the image display lights are adjusted by the light adjustment unit 531, the green image display light (indicated by a solid line) reaches the entrance portion 541-1 of the light guide plate 540-1. The entrance portion 541-1 causes the green image display light to travel into the light guide plate 540-1. For example, the entrance hologram 542-1 is provided at the entrance portion 541-1, to cause the green image display light to travel into the light guide plate 540-1. The entrance hologram 542-1 may be a holographic optical element (HOE), for example. The entrance hologram 542-1 may also have optical characteristics to selectively diffract the green image display light.

As the image display lights are adjusted by the light adjustment unit, the magenta image display light (indicated by a dashed line) reaches the entrance portion 541-2 of the light guide plate 540-2. The entrance portion 541-2 causes the magenta image display light to travel into the light guide plate 540-2. For example, the entrance hologram 542-2 is provided at the entrance portion 541-2, to cause the magenta image display light to travel into the light guide plate 540-2. The entrance hologram 542-2 may be a holographic optical element (HOE), for example. The entrance hologram 542-2 may also have optical characteristics to selectively diffract the magenta image display light.

The liquid crystal element or MEMS mirror of the light adjustment unit 531 may change its steering so that the angles of view of the respective images formed by the two image display lights guided in the two light guide plates 540-1 and 540-2 become the same. For example, the steering can be adjusted so that the angle of view of the image formed by the green image display light can be matched with the angle of view of the image formed by the magenta image display light.

The light adjustment unit 531 may be designed so that its overall position and/or angle can be adjusted. With this arrangement, the projection position or the angle of the entire image can be adjusted.

The light guide plates 540-1 and 540-2, and the entrance portions and the exit portions provided in these light guide plates are the same as the light guide plates 140-1 and 140-2, and the entrance portions and the exit portions provided in these light guide plates described above in “(2) First Example of the First Embodiment (an Example of an Image Display Device)”. Therefore, explanation of these components is not made herein.

In this embodiment, the liquid crystal element or the MEMS mirror of the light adjustment unit 531 is changed, or the hologram formed by the liquid crystal element of the light adjustment unit 531 is controlled, so that a registration difference between plurality of images formed by image display lights of different colors can be eliminated. Therefore, the relative positional relationship between the two light guide plates 540-1 and 540-2 does not have to be strictly controlled. For example, as a registration difference can be eliminated by the light adjustment unit 531, the securing operation to be performed on the light guide plates 540-1 and 540-2 by securing members 545 and 546 can be simplified.

Further, as described above in “(2) First Example of the First Embodiment (an Example of an Image Display Device)”, it is also possible to adjust the entire light adjustment unit and adjust convergence.

### (5) Fourth Example of the First Embodiment (Another Example of an Image Display Device)

According to another embodiment of the present technology, the light adjustment unit may include at least one mirror having a lens function. An example of an image display device according to this embodiment is described below with reference to FIG. 6.

FIG. 6 shows an example schematic diagram of an image display device 600 according to the present technology. The image display device 600 includes an optical engine 610 and a light guide optical system 620. Because the optical engine 610 is the same as the optical engine 110 described above in “(2) First Example of the First Embodiment (an Example of an Image Display Device)”, explanation thereof is not made herein. The light guide optical system 620 is the same as the light guide optical system 620 described above in “(2) First Example of the First Embodiment (an Example of an Image Display Device)”, except that a mirror 631-2 included in a light adjustment unit 631 differs from the mirror 131-2 in having a lens function. Therefore, in the description below, mainly the mirror 631-2 will be explained. As for the other components, refer to the above description in “(2) First Example of the First Embodiment (an Example of an Image Display Device)”.

The mirror 631-2 can reflect the image display light that should be guided by a light guide plate 640-2 among the image display lights having passed through a mirror 631-1, and pass the other image display lights. That is, the mirror 631-2 may be a dichroic mirror. Alternatively, the mirror 631-2 may reflect all the image display light that has passed through the mirror 631-1.

The mirror 631-2 may be a mirror having a lens function. With the lens function, it is possible to correct chromatic aberration that is not corrected by the optical engine 610. With this arrangement, it is possible to enable the eye 650 to view a better image.

The lens action of the mirror 631-2 may be appropriately selected by a person skilled in the art in accordance with the chromatic aberration of the optical engine 610, and a person skilled in the art can manufacture a mirror having a desired lens function.

### 2. Second Embodiment (A Head-Mounted Display)

The present technology also provides a head-mounted display that includes at least one image display device including: an optical engine that emits image display light; and a light guide optical system that guides the image display light emitted from the optical engine to an eye. The light guide optical system includes: a light adjustment unit that adjusts the image display light emitted from the optical engine; and at least one light guide plate that guides the image display light adjusted by the light adjustment unit to the eye through the inside of the at least one light guide plate. The at least one light guide plate includes: an entrance portion that causes the image display light adjusted by the light adjustment unit to travel into the light guide plate; and an exit portion that causes the image display light having traveled in the light guide plate to exit the light guide plate and reach the eye.

Since the head-mounted display according to the present technology includes an image display device including the light adjustment unit, a difference in the angle of view can be eliminated by the light adjustment unit. The image display device is as described above in “1. First Embodiment (an Image Display Device)”, and the description also applies to this embodiment.

The head-mounted display may be an eyewear-like display. The head-mounted display may include a support in the form of a spectacle frame and two image display devices according to the present technology mounted on the support, for example, as shown in FIG. 3 described above in “(2) First Example of the First Embodiment (an Example of an Image Display Device)” of Chapter 1. That is, one image display device may be disposed so that image display light reaches one of the eyes, and the other image display device may be disposed so that image display light reaches the other one of the eyes.

Alternatively, the head-mounted display may include one image display device according to the present technology, and a support for mounting the image display device on the head. That is, the image display device may be disposed so that image display light reaches only one eye.

With a head-mounted display having the above configuration, AR can be provided to the user of the display.

### 3. Third Embodiment (A Method for Manufacturing an Image Display Device)

The present technology also provides a method for manufacturing an image display device. The manufacturing method includes: an assembly process of assembling an image display device from an optical engine that emits image display light, a light adjustment unit that adjusts the image display light emitted from the optical engine, and at least one light guide plate in such a manner that the image display light adjusted by the light adjustment unit is made to travel in the at least one light guide plate and is guided to an eye; and an adjustment process of adjusting the light adjustment unit so that the image display light emitted from the optical engine reaches a desired position in the at least one light guide plate, after the assembly process. The assembly process may include: a light guide plate securing process of securing the position of the at least one light guide plate; and an introduction process of introducing a component other than the at least one light guide plate, for example.

By the manufacturing method according to the present technology, the adjustment process is performed after the assembly process, and, in the adjustment process, adjustment is performed so that image display light reaches a desired position in the at least one light guide plate. Thus, an image display device in which any difference in angle of view is eliminated is manufactured. With this arrangement, there is no need for precise adjustment of arrangement of the respective parts in the assembly process (such as adjustment of the positions of light guide plates, and adjustment of the arrival positions of image display lights in the light guide plates, for example). As a result, the manufacturing equipment can be simplified.

In the assembly process, two image display devices may be assembled from two sets of the optical engine, the light adjustment unit, and the at least one light guide plate. In the adjustment process, the light adjustment unit included in one or both of the two image display devices may be adjusted so that the angle of convergence is adjusted, or the image signal directed to the image display element of the optical engine included in one or both of the two image display devices may be adjusted so that the angle of convergence is adjusted. In this manner, a head-mounted display such as an eyewear-like display that includes two image display devices and has an adjusted angle of convergence can be manufactured, for example.

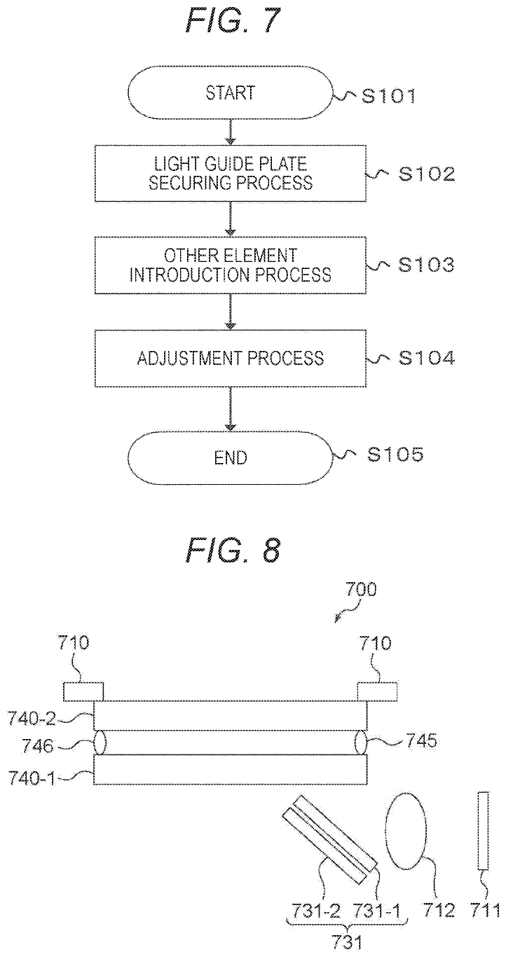

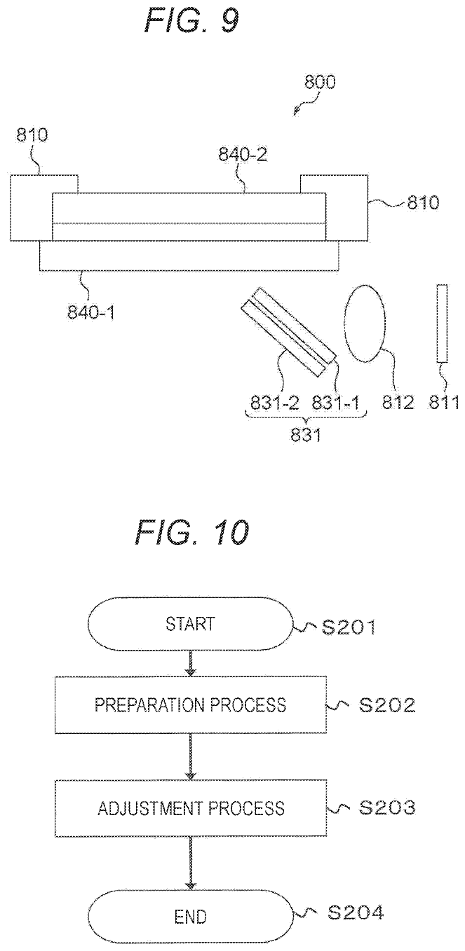

An example of a manufacturing method according to the present technology is described below, with reference to FIGS. 7 to 9. FIG. 7 is a diagram showing an example flow of a manufacturing method according to the present technology. FIGS. 8 and 9 are schematic diagrams showing examples of image display devices according to the present technology including two light guide plates.

In step S101 in FIG. 7, the manufacturing method according to the present technology is started.

A light guide plate securing process in step S102 and an other element introduction process in step S103 correspond to the assembly process.

In the description below, an example of step S102 to be carried out in the manufacture of an image display device 700 shown in FIG. 8 is explained. The image display device 700 includes two light guide plates 740-1 and 740-2. The light guide plate 740-2 is secured to a frame 710, and the light guide plate 740-1 is secured to the light guide plate 740-2.

In step S102, the relative positional relationship between the two light guide plates 740-1 and 740-2 is secured. The following procedures may be carried out to secure the positional relationship.

First, the light guide plate 740-2 is secured to the frame 710. The frame 710 may be a spectacle-like frame (part of the spectacle-like frame 710 is shown in FIG. 8), for example. The light guide plate 740-2 may have the shape of a spectacle lens. A securing member (not shown) can be used to secure the frame 710 to the light guide plate 740-2. The securing member may be an adhesive agent or adhesive paper, for example.

Next, the light guide plate 740-1 is secured to the light guide plate 740-2 via securing members 745 and 746. The securing members 745 and 746 may also be an adhesive agent or adhesive paper, for example. In the above manner, the relative positional relationship between the light guide plates 740-1 and 740-2 is secured.

Note that entrance portions and exit portions, and entrance holograms and exit holograms included in the entrance and exit portions as described above are provided in the light guide plates 740-1 and 740-2, but are not shown in FIG. 8.

As described above, between the two light guide plates 740-1 and 740-2 included in the image display device 700, the light guide plate 740-2 is secured to the frame, and the other light guide plate 740-1 is secured to the light guide plate 740-2.

The method for securing two light guide plates is not limited to the method described above. As another example, step S102 that may be carried out in the manufacture of an image display device 800 shown in FIG. 9 is now described. The image display device 800 includes two light guide plates 840-1 and 840-2, and both of the light guide plates are secured to a frame 810.

In step S102, the relative positional relationship between the two light guide plates 840-1 and 840-2 is secured. The following procedures may be carried out to secure the positional relationship.

First, the light guide plate 840-2 is secured to the frame 810. The frame 810 may be a spectacle-like frame (part of the spectacle-like frame 810 is shown in FIG. 9), for example. The light guide plate 840-2 may have the shape of a spectacle lens. A securing member (not shown) can be used to secure the frame 810 to the light guide plate 840-2. The securing member may be an adhesive agent or adhesive paper, for example.

Next, the light guide plate 840-1 is further secured to the frame 810 via a securing member (not shown). The securing member may also be an adhesive agent or adhesive paper, for example. In the above manner, the relative positional relationship between the light guide plates 840-1 and 840-2 is secured.

Note that entrance portions and exit portions, and entrance holograms and exit holograms included in the entrance and exit portions as described above are provided in the light guide plates 840-1 and 840-2, but are not shown in FIG. 9.

As described above, both of the two light guide plates 840-1 and 840-2 included in the image display device 800 are secured to the frame 810.

Note that, in a case where the number of light guide plates is one, the light guide plate can be secured to a spectacle-like frame, for example, in step S102. In a case where the number of light guide plates is three or larger, the three or more light guide plates can be secured with securing members in step S102 as described above with reference to FIGS. 8 and 9. Further, the light guide plate(s) to be used in step S102 may be the same as that (those) described above in “1. First Embodiment (an Image Display Device)”.

In step S103, other elements constituting the image display device may be introduced. For example, the optical engine and the light adjustment unit can be introduced to form the image display device according to the present technology. The optical engine and the light adjustment unit to be used in step S103 may be the same as those described above in “1. First Embodiment (an Image Display Device)”. Also, in step S103, the image display device can be assembled so that the image display light adjusted by the light adjustment unit is made to travel in the at least one light guide plate (the light guide plates 740-1 and 740-2, or the light guide plates 840-1 and 840-2 in the image display devices shown in FIGS. 8 and 9), and is guided to the eye. The image display device to be assembled may be the same as the image display device described above in “1. First Embodiment (an Image Display Device)”, for example.

As for the image display device 700 shown in FIG. 8, for example, two mirrors 731-1 and 731-2 constituting a light adjustment unit 731, and an image display element 711 and a collimator lens 712 constituting the optical engine can be introduced into the frame 710 or a housing (not shown) attached to the frame 710.

Likewise, as for the image display device 800 shown in FIG. 9, for example, two mirrors 831-1 and 831-2 constituting a light adjustment unit 831, and an image display element 811 and a collimator lens 812 constituting the optical engine can be introduced into the frame 810 or a housing (not shown) attached to the frame 810.

In step S103, other elements for forming the image display device may be further introduced. For example, the control unit, the disk, the communication device, the drive, and the like described above may be introduced to form the image display device in step S103. These elements may be attached to the frame, for example, or may be introduced into a housing attached to the frame.

Note that the sequence of steps S102 and S103, and the order of introducing the respective components may be appropriately selected by a person skilled in the art. For example, step S102 may be followed by step S103, step S103 may be followed by step S102, or steps S102 and S103 may be carried out as one process.

In step S104, the light adjustment unit is adjusted so that the image display light emitted from the optical engine reaches a desired position in the at least one light guide plate. The adjustment may be any of the adjustment processes described above in “1. First Embodiment (an Image Display Device)”, for example. In the adjustment, for example, any difference in angle of view between two or more images formed by two or more image display lights having different wavelength components can be eliminated. The difference in angle of view can be eliminated by adjustment of the positions and/or the angles of the mirrors included in the light adjustment unit, for example. Thus, the image display device in which any difference in angle of view is eliminated is manufactured.

In step S105, the manufacturing method according to the present technology comes to an end.

### 4. Fourth Embodiment (A Method for Adjusting an Image Display Device)

The present technology also provides a method for adjusting an image display device. The method includes: a preparation process of preparing an image display device including an optical engine that emits image display light, a light adjustment unit that adjusts the image display light emitted from the optical engine, and at least one light guide plate that causes the image display light adjusted by the light adjustment unit to travel in the at least one light guide plate and guides the image display light to the eye; and an adjustment process of adjusting the light adjustment unit so that the image display light emitted from the optical engine reaches a desired position in the at least one light guide plate.

In the adjustment method according to the present technology, for example, any difference in angle of view can be eliminated by the adjustment process. Therefore, for example, precise adjustment of arrangement of the respective parts (such as adjustment of the positions between light guide plates, and adjustment of the arrival positions of image display lights in the light guide plates, for example) is not necessarily performed to eliminate a difference in angle of view. Accordingly, the image display device can be easily repaired or adjusted.

An example of a manufacturing method according to the present technology is described below, with reference to FIG. 10. FIG. 10 is a diagram showing an example flow of an adjustment method according to the present technology.

In step S201, the adjustment method according to the present technology is started.

In step S202, an image display device including the optical engine, the light adjustment unit, and the at least one light guide plate is prepared. These parts and the image display device may be the same as those described above in “1. First Embodiment (an Image Display Device)”.

In step S203, the light adjustment unit is adjusted so that the image display light emitted from the optical engine reaches a desired position in the at least one light guide plate. The adjustment may be any of the adjustment processes described above in “1. First Embodiment (an Image Display Device)”, for example. In the adjustment, for example, any difference in angle of view between two or more images formed by two or more image display lights having different wavelength components can be eliminated. The difference in angle of view can be eliminated by adjustment of the positions and/or the angles of the mirrors included in the light adjustment unit, for example. As a result, any difference in angle of view is eliminated.

In step S204, the adjustment method according to the present technology comes to an end.

Note that the present technology may also be embodied in the configurations described below.
[1] An image display device including:

an optical engine that emits image display light; and a light guide optical system that guides the image display light emitted from the optical engine to an eye,

in which

the light guide optical system includes:

a light adjustment unit that adjusts the image display light emitted from the optical engine; and

at least one light guide plate that causes the image display light adjusted by the light adjustment unit to travel in the at least one light guide plate, and guides the image display light to the eye, and

the at least one light guide plate includes:

an entrance portion that causes the image display light adjusted by the light adjustment unit to travel into the light guide plate; and

an exit portion that causes the image display light having traveled in the light guide plate to exit the light guide plate and reach the eye.
[2] The image display device according to [1], in which the light adjustment unit reflects or refracts the image display light emitted from the optical engine, and causes the image display light to travel to the entrance portion.
[3] The image display device according to [1] or [2], in which the entrance portion diffracts the image display light adjusted by the light adjustment unit, and causes the image display light to travel into the light guide plate.
[4] The image display device according to any one of [1] to [3], in which

the light adjustment unit divides the image display light emitted from the optical engine into two or more lights having different wavelength components, and causes the lights to travel to the entrance portion.
[5] The image display device according to [4], in which

the light guide optical system includes two or more light guide plates,

an entrance hologram is provided at an entrance portion of each of the two or more light guide plates, and

the entrance hologram diffracts one of the two or more lights divided by the light adjustment unit, and causes the diffracted light to travel into the light guide plate.
[6] The image display device according to [5], in which

an exit hologram is provided at an exit portion of each of the two or more light guide plates, and

the exit hologram diffracts the light having traveled in the light guide plate, and causes the light to exit the light guide plate.
[7] The image display device according to [4], in which

the light guide optical system includes one light guide plate,

an entrance hologram is provided at an entrance portion of the one light guide plate, and

the entrance hologram diffracts the two or more lights divided by the light adjustment unit, and causes the diffracted lights to travel into the light guide plate.
[8] The image display device according to [7], in which the entrance hologram is a hologram stack.
[9] The image display device according to [7] or [8], in which

an exit hologram is provided at an exit portion of the one light guide plate, and

a diffraction pitch of the exit hologram differs from a diffraction pitch of the entrance hologram.
[10] The image display device according to [4], in which

the light adjustment unit includes at least one dichroic mirror, and

the image display light emitted from the optical engine is divided into the two or more lights by the at least one dichroic mirror.
[11] The image display device according to [4], in which

the light guide optical system includes two or more light guide plates,

the light adjustment unit includes one liquid crystal element or MEMS mirror, and

the one liquid crystal element or MEMS mirror switches the light guide plates to which the image display light emitted from the optical engine is to be guided.
[12] The image display device according to [11], in which

the optical engine is driven by a field sequential method, and

the one liquid crystal element or MEMS mirror changes steering, in synchronization with the driving by the field sequential method.
[13] The image display device according to [11], in which

the light guide optical system includes two or more light guide plates,

the light adjustment unit includes one liquid crystal element, and

a hologram generated by the liquid crystal element switches the light guide plates to which the image display light emitted from the optical engine is to be guided.
[14] The image display device according to any one of [1] to [10], in which

the light adjustment unit includes at least one mirror having a lens function.
[15] The image display device according to any one of [1] to [14], in which a position and/or an orientation of the entire light adjustment unit can be adjusted, to cause the image display light emitted from the optical engine to reach a desired position in the at least one light guide plate.
[16] The image display device according to any one of [1] to [15], in which an image signal directed to an image display element included in the optical engine can be adjusted, to cause the image display light emitted from the optical engine to reach a desired position in the at least one light guide plate.
[17] A head-mounted display including

at least one image display device including: an optical engine that emits image display light; and a light guide optical system that guides the image display light emitted from the optical engine and causes the image display light to reach an eye,

in which

the light guide optical system includes: a light adjustment unit that adjusts the image display light emitted from the optical engine; and at least one light guide plate that causes the image display light adjusted by the light adjustment unit to travel in the at least one light guide plate, and guides the image display light to the eye, and

the at least one light guide plate includes: an entrance portion that causes the image display light adjusted by the light adjustment unit to travel into the light guide plate; and an exit portion that causes the image display light having traveled in the light guide plate to exit the light guide plate and reach the eye.
[18] A method for manufacturing an image display device,

including:

an assembly process of assembling an image display device from an optical engine that emits image display light, a light adjustment unit that adjusts the image display light emitted from the optical engine, and at least one light guide plate, to cause the image display light adjusted by the light adjustment unit to travel in the at least one light guide plate and guide the image display light to an eye; and

an adjustment process of adjusting the light adjustment unit, to cause the image display light emitted from the optical engine to reach a desired position in the at least one light guide plate, after the assembly process.
[19] The method for manufacturing an image display device according to [18], in which,

in the assembly process, two image display devices are assembled from two sets of the optical engine, the light adjustment unit, and the at least one light guide plate, and,

in the adjustment process, the light adjustment unit included in one or both of the two image display devices is adjusted, to adjust an angle of convergence, or an image signal directed to an image display element of the optical engine included in one or both of the two image display devices is adjusted, to adjust the angle of convergence.
[20] A method for adjusting an image display device, including:

a preparation process of preparing an image display device including: an optical engine that emits image display light; a light adjustment unit that adjusts the image display light emitted from the optical engine; and at least one light guide plate that causes the image display light adjusted by the light adjustment unit to travel in the at least one light guide plate and guides the image display light to an eye; and

an adjustment process of adjusting the light adjustment unit, to cause the image display light emitted from the optical engine to reach a desired position in the at least one light guide plate.

### REFERENCE SIGNS LIST

100 Image display device
110 Optical engine
111 Image display element
112 Collimator lens
120 Light guide optical system
131 Light adjustment unit
140-1 and 140-2 Light guide plate

What is claimed is:

1. An image display device comprising:
an optical engine that emits image display light; and a light guide optical system that guides the image display light emitted from the optical engine to an eye,
wherein
the light guide optical system includes:
a light adjustment unit that adjusts the image display light emitted from the optical engine; and
at least one light guide plate that causes the image display light adjusted by the light adjustment unit to travel in the at least one light guide plate, and guides the image display light to the eye, and
the at least one light guide plate includes:
an entrance portion that causes the image display light adjusted by the light adjustment unit to travel into the light guide plate; and
an exit portion that causes the image display light having traveled in the light guide plate to exit the light guide plate and reach the eye.

2. The image display device according to claim 1, wherein the light adjustment unit reflects or refracts the image display light emitted from the optical engine, and causes the image display light to travel to the entrance portion.

3. The image display device according to claim 1, wherein the entrance portion diffracts the image display light adjusted by the light adjustment unit, and causes the image display light to travel into the light guide plate.

4. The image display device according to claim 1, wherein
the light adjustment unit divides the image display light emitted from the optical engine into two or more lights having different wavelength components, and causes the two or more lights to travel to the entrance portion.

5. The image display device according to claim 4, wherein
the light guide optical system includes two or more light guide plates,
an entrance hologram is provided at an entrance portion of each of the two or more light guide plates, and
the entrance hologram diffracts one of the two or more lights divided by the light adjustment unit, and causes the diffracted light to travel into the light guide plate.

6. The image display device according to claim 5, wherein
an exit hologram is provided at an exit portion of each of the two or more light guide plates, and
the exit hologram diffracts the light having traveled in the light guide plate, and causes the light to exit the light guide plate.

7. The image display device according to claim 4, wherein
the light guide optical system includes one light guide plate,
an entrance hologram is provided at an entrance portion of the one light guide plate, and
the entrance hologram diffracts the two or more lights divided by the light adjustment unit, and causes the diffracted lights to travel into the light guide plate.

8. The image display device according to claim 7, wherein the entrance hologram is a hologram stack.

9. The image display device according to claim 7, wherein
an exit hologram is provided at an exit portion of the one light guide plate, and
a diffraction pitch of the exit hologram differs from a diffraction pitch of the entrance hologram.

10. The image display device according to claim 4, wherein
the light adjustment unit includes at least one dichroic mirror, and
the image display light emitted from the optical engine is divided into the two or more lights by the at least one dichroic mirror.

11. The image display device according to claim 4, wherein
the light guide optical system includes two or more light guide plates,
the light adjustment unit includes one liquid crystal element or MEMS mirror, and
the one liquid crystal element or MEMS mirror switches the light guide plates to which the image display light emitted from the optical engine is to be guided.

12. The image display device according to claim 11, wherein
the optical engine is driven by a field sequential method, and
the one liquid crystal element or MEMS mirror changes steering, in synchronization with the driving by the field sequential method.

13. The image display device according to claim 11, wherein
the light guide optical system includes two or more light guide plates,
the light adjustment unit includes one liquid crystal element, and
a hologram generated by the liquid crystal element switches the light guide plates to which the image display light emitted from the optical engine is to be guided.

14. The image display device according to claim 1, wherein
the light adjustment unit includes at least one mirror having a lens function.

15. The image display device according to claim 1, wherein a position and/or an orientation of the entire light adjustment unit can be adjusted, to cause the image display light emitted from the optical engine to reach a desired position in the at least one light guide plate.

16. The image display device according to claim 1, wherein an image signal directed to an image display element included in the optical engine can be adjusted, to cause the image display light emitted from the optical engine to reach a desired position in the at least one light guide plate.

17. A head-mounted display comprising
at least one image display device including: an optical engine that emits image display light; and a light guide optical system that guides the image display light emitted from the optical engine and causes the image display light to reach an eye,
wherein
the light guide optical system includes: a light adjustment unit that adjusts the image display light emitted from the optical engine; and at least one light guide plate that causes the image display light adjusted by the light adjustment unit to travel in the at least one light guide plate, and guides the image display light to the eye, and
the at least one light guide plate includes: an entrance portion that causes the image display light adjusted by the light adjustment unit to travel into the light guide plate; and an exit portion that causes the image display light having traveled in the light guide plate to exit the light guide plate and reach the eye.

18. A method for manufacturing an image display device, comprising:
an assembly process of assembling an image display device from an optical engine that emits image display light, a light adjustment unit that adjusts the image display light emitted from the optical engine, and at least one light guide plate, to cause the image display light adjusted by the light adjustment unit to travel in the at least one light guide plate and guide the image display light to an eye; and
an adjustment process of adjusting the light adjustment unit, to cause the image display light emitted from the optical engine to reach a desired position in the at least one light guide plate, after the assembly process.

19. The method for manufacturing an image display device according to claim 18, wherein,
in the assembly process, two image display devices are assembled from two sets of the optical engine, the light adjustment unit, and the at least one light guide plate, and,
in the adjustment process, the light adjustment unit included in one or both of the two image display devices is adjusted, to adjust an angle of convergence, or an image signal directed to an image display element of the optical engine included in one or both of the two image display devices is adjusted, to adjust the angle of convergence.

20. A method for adjusting an image display device, comprising:
a preparation process of preparing an image display device including: an optical engine that emits image display light; a light adjustment unit that adjusts the image display light emitted from the optical engine; and at least one light guide plate that causes the image display light adjusted by the light adjustment unit to travel in the at least one light guide plate and guides the image display light to an eye; and
an adjustment process of adjusting the light adjustment unit, to cause the image display light emitted from the optical engine to reach a desired position in the at least one light guide plate.
